(19) United States
(12) Patent Application Publication
(10) Pub. No.: US 2017/0114509 A1
(43) Pub. Date: Apr. 27, 2017

(54) METHOD OF MAINTAINING AN UNMETALLED ROADWAY DURING LOAD TRANSFER AND A VEHICLE THEREFOR

(71) Applicant: JOHN CHARLES SHAKESPEARE, Shrewsbury Shropshire (GB)

(72) Inventor: JOHN CHARLES SHAKESPEARE, Shrewsbury Shropshire (GB)

(21) Appl. No.: 15/310,689

(22) PCT Filed: May 12, 2015
(86) PCT No.: PCT/EP2015/060529

§ 371 Date: Nov. 11, 2016

(30) Foreign Application Priority Data
May 12, 2014 (GB) 1408304.2

(51) Int. Cl. E01C 23/082; E02F 3/76; B60P 1/04

(52) U.S. Cl. CPC E01C 23/082; B60P 1/04; E02F 3/7636

(57) ABSTRACT

A method of maintaining a roadway (2) during transfer of a load from a first location to a second location by a motorised vehicle (1) is described. The vehicle (1) may be a dumper truck and has a retractable blade (8) movable relative to the vehicle (1) between a retracted position (FIG. 1) and a working position (FIG. 2). The load is transferred in the vehicle (1) from the first location to the second location along the roadway (2), the blade (8) is moved to the working position after dumping the load and on the return journey the vehicle (1) acts as a grader to smooth undulations and ruts. The blade (8) is pivotally mounted and located between the front axle (5) and the rear axle (6, 7) and does not extend beyond the width of the vehicle. Unmetalled roadways on construction sites, quarries and mines may be maintained in good condition without the need to employ additional vehicles or hire separate grader vehicles.

This invention relates to a method of maintaining an unmetalled roadway during load transfer and a vehicle therefor. In particular, the method enables a roadway which is repeatedly used by one or more vehicles carrying loads and susceptible to wear or rutting to be maintained by selective application of a retractable grader on the vehicle, especially while the vehicle is unladen for example during return journeys on the roadway.

As employed herein, the term “roadway” refers to any surface which is not metalled and over which vehicles, particularly construction vehicles, may pass and cause rutting or other deterioration of the surface and which periodically requires remedial action, for example by smoothing or re-levelling with a conventional grader.

Roads are typically constructed of various materials including asphalt, concrete, gravel and the like and whilst they need repair or relaying from time to time, are generally robust. Typically they comprise a solid body of material which forms the surface and sublayers and may include a loose material on the solid surface, for example gravel, chippings or the like. Solid roads whether metalled or unmetalled may have their top surface constructed or maintained by applying a grader blade to move loose surface material around the solid surface so as to fill-in holes or other uneven areas by redistributing loose material using a grader blade whereby the loose material passes over the uneven area and is deposited or drops into the uneven area and below the bottom of the grader blade, thereby smoothing the surface of the road.

Ground leveling vehicles, for example useful in landscape garden, maintenance of playing fields, golf courses and the like and which have a grader blade are described in JP2009249961 and JP S4918302 which show small vehicle with a fixed base and are adapted to move loose material above the solid surface so as to reduce unevenness.

By contrast, roadways on construction sites, open-cast mines, quarries and the like where vehicles transport heavy loads are often unmetalled and the surface may be soil, sand, gravel or other loose material and deteriorate rapidly due to the weight of one or more vehicles with a load repeatedly passing over the same roadway while transporting loads from a first location to another. Deterioration, typically the formation of ruts through displacement of the surface, may occur very rapidly and render the roadway unusable or at least more difficult to use until remediation work to restore a usable surface is carried out. The rate and degree of deterioration is typically exacerbated by rain and formation of ruts may lead to flooding.

Such deteriorated roadways, are typically repaired by heavy plant which is specifically brought in and moves the higher “crests” of the roadway into the “troughs” and so reconfigures the roadway itself. This is to be contrasted to conventional grading operations as described above in which loose material above the surface is redistributed around it to repair potholes and the like.

Increased difficulty of use or having to halt activity to allow remedial work through separate plant brought in specifically for the purpose slows production and increases cost. For example, in order to maintain a given level of production, more vehicles may be required or alternatively, a grader may be used but this involves costs of purchase or hire of a grader and lost production time whilst the roadway is repaired.

The invention solves this problem through the realisation that the vehicle which carries the load from a first location to a second location necessarily makes return journeys while unladen and may also perform a repairing function at least during the return journey and, if desired during the outward journey while laden in addition to the primary function of transferring the load to the second location.

In a first aspect the invention provides a method of maintaining an unmetalled roadway is susceptible to deterioration the roadway being maintained during an operation to transfer a load from a first location to a second location by a repeated transit of a motorised vehicle along the roadway which, in an outward pass from the first location to the second location is laden with a part of the load and which in a return pass from the second location to the first location is unladen wherein the motorised vehicle comprises an open box bed for carrying the part of the load and a retractable blade which is movable relative to the said vehicle between a retracted position and a working position, the method comprising:
i) moving the part of the load in the said vehicle in the outward pass from the first location to the second location along the unmetalled roadway;
ii) depositing the part of the load at the second location;
iii) returning the vehicle in the return pass to the first location along the unmetalled roadway with the blade in the working position such that the blade is applied to the roadway during the return pass to reduce undulations or ruts and repair at least in part deterioration in the roadway; and
iv) repeating steps i) to iii) at least once so as to move the load from the first location to the second location and to maintain the roadway during the return pass.

Advantageously, the invention provides a method of transporting a load along a roadway and maintaining the roadway during a return journey using the same vehicle or vehicles to repair the roadway as used for transporting the load and which has caused the roadway to deteriorate. A further advantage arises as the vehicle performs the maintenance or repair function of the unmetalled roadway during the timeframe allocated for moving the load. As such, it is not necessary to halt operations and allocate a separate timeframe for repair of the deteriorated roadway.

The maintenance of the roadway involves moving parts of the roadway which have been undesirably displaced during the outward pass into a more desirable location whereby the roadway is maintained in a serviceable manner. The blade suitably engages with displaced parts of the roadway and moves the displaced material to a location which requires filling, for example into a rut. This activity is to be contrasted with a conventional grading operation in which the toad comprises a solid surface and subsurface and grading moves loose material around on the top of the surface to fill in pot-holes on the like but does not reconfigure material of the solid part of the road which has been displaced in a prior pass of the grading vehicle whilst carrying a load.

As well as being in the working position on the return pass, the blade may be in the working position during the outward pass. As desired, the blade may contact the roadway so as to reshape the surface of the roadway thereby to reduce undulations or ruts and repair at least in part deterioration in the roadway.

Preferably the motorised vehicle is articulated and comprises a front part carrying a driver cabin and at least one axle and a rear part comprising the open box bed and at least one axle wherein the front part and the rear part are linked by an articulated connection and the rear part carries the blade which is located forward of the at least one axle on the rear part and, where there is more than one axle on the rear part, preferably forward of all the rear axles. By providing articulation, the front part of the vehicle may move independently of the rear part such that as ruts, holes, undulations or the like are encountered the front part may move relative to the rear part and relative to the blade which advantageously reduces the risks of suddenly increasing the torque demand on the engine of the vehicle beyond the limits of intended normal operation.

By reducing the number of ruts, undulations or other unevenness or reducing their depth, the roadway is maintained to provide a smoother roadway which allows vehicles to travel faster on the roadway, enables smaller vehicles to use the roadway where otherwise the ruts may limit or preclude such use, reduce wear and tear on vehicles and to reduce discomfort for vehicle drivers using the roadway.

Advantageously, production levels may be maintained as vehicles will be able to maintain an appropriate speed which obviates the need for using additional vehicles. Further, costs associated with hiring a conventional grader may be avoided or reduced as the vehicle will maintain the roadway on a journey that it would in any event still need to make. The roadway may accordingly be maintained for minimal additional cost.

In a second aspect, the invention relates to a motorised vehicle having an open box bed for carrying a load, a driver cabin, a front axle and at least one rear axle and a retractable blade pivotally mounted to the vehicle such that it is movable between a retracted position and a working position, the blade being located between the front axle and the at least one rear axle and wherein the blade does not extend beyond the width of the vehicle.

The invention also provides for the use of a vehicle according to the invention for maintaining a roadway during transferral of a load from a first location to a second location.

Advantageously, as the front wheels of the vehicle enter a hole or rut and the vehicle pitches forward, the blade will move with the vehicle but will drop to a lesser degree than the front wheels depending on the location of the blade between the front and rear axles and thereby remove part of the undulations but not all of it in a single pass. Repeated passes will progressively reduce the undulation without putting undue strain on the vehicle or blade and thereby assist in maintaining the roadway.

Preferably, the motorised vehicle is a dumper truck typically used for off-road construction or a tipper lorry. The vehicle may be power by any conventional means, for example a diesel and electric power train. Suitably, the vehicle comprises at least three axles, one at the front of the vehicle and at least two to the rear of the vehicle and the blade is located between the front axle and the forward-most axle of those axles towards the rear of the vehicle.

Suitably, the motorised vehicle comprises a front part carrying a driver cabin and a rear part comprising the open box bed wherein the front part and the rear part are linked by an articulated connection. Preferably the front part carries one or two axles and the rear part carries two to four axles and the blade is located forward of all the axles on the rear part.

The blade is suitably movable between a retracted position in which the blade is generally parallel to a plane through the front and rear axles and a working position where the blade contacts the ground. Preferably, in the working position the bottom of the blade is at the same level as the ground contact of the wheels rearward of the blade such that the blade does not dig in to the surface which is to be graded and is less likely to foul hard objects.

Suitably, the blade and open box bed are independently operable. The blade may be moved relative to the vehicle without requiring the vehicle to move.

Preferably, the blade is hydraulically operable. The open box bed is suitably hydraulically operable. Suitably, the blade and open box bed are operable using a single hydraulic circuit and preferably are operable independently of each other, for example using a valve block.

In a preferred option the blade is mounted on the vehicle by means of a mounting assembly. The mounting assembly suitably comprises a connecting part mounted on the vehicle and the blade is rotatably mounted on the connecting part for rotation about an axis which is transverse to the vehicle, an actuation part which is pivotally connected to the blade such that upon movement of the actuation part, the blade rotates about the transverse axis of rotation and a one hydraulic ram operably connected to the connecting part and the actuation part such that upon movement of the ram, the actuation part is caused to move relative to the connecting part so as to effect rotation of the blade. The stroke of the hydraulic ram may be used to control the degree of rotation of the blade and hence its working height and attitude to the surface to be graded. The blade is suitably mounted in such a manner that when in the working position, the blade is able to avoid obstructions or hard objects under the surface of the roadway.

Preferably the blade is retractable to a position which is above the lowest part of the underside of the vehicle, for example the differential casing on a dumper truck, so as to reduce the risk of fouling when employed in extremely uneven conditions.

In a preferred embodiment, the blade is mounted on the vehicle by two mounting assemblies, located either side of the longitudinal axis of the vehicle.

The blade and mounting assembly may be produced separately to the vehicle enabling retrofitting to existing vehicles or may be designed as an integral part of the vehicle as desired.

The motorised vehicle is suitably at least 10 tonnes, at least 20 tonnes and may be up to 50 tonnes or more as the problem of deterioration of a roadway during movement of a load arises particularly with a larger vehicle. Suitably, the vehicle is equipped to operate at a very high torque at low speed so as to allow the blade to reconfigure and repair the roadway with reduced risk of undue engine loading or stalling. Suitably, the vehicle has similar engine performance as regards torque and power output as conventional loaders or wheeled loaders, known in the art whilst also being able to operate at higher speeds during the outward pass of the loading operation.

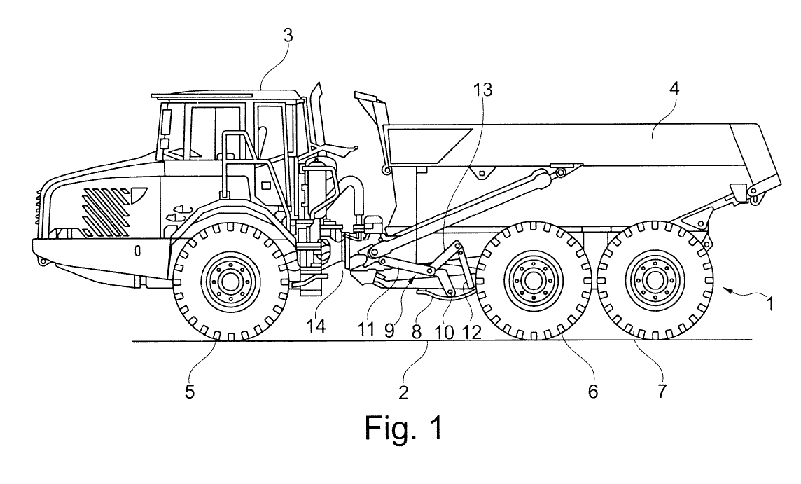

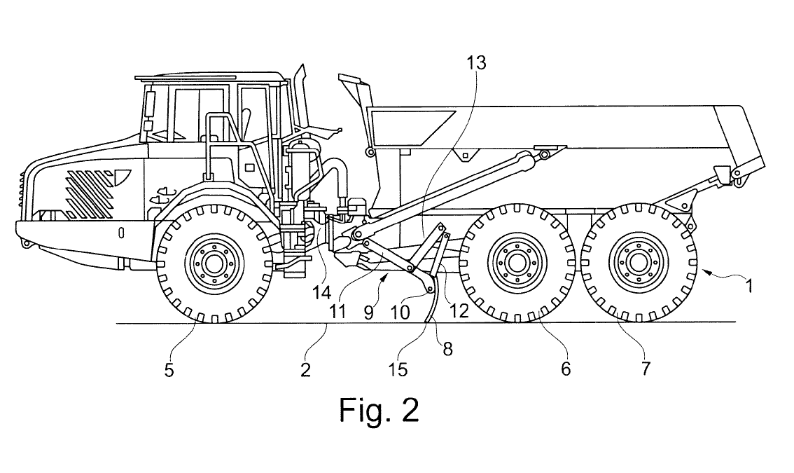

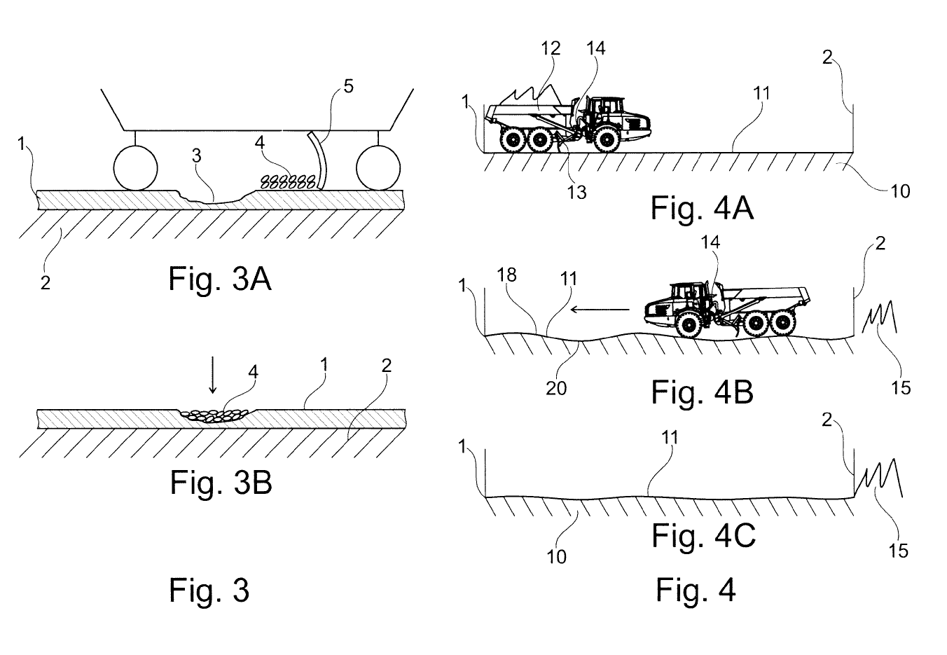

The invention is illustrated by the accompanying drawings in which:
FIG. 1 shows a side view of a vehicle according to the invention with the blade in the retracted position;
FIG. 2 shows a side view of the vehicle in FIG. 1 with the blade in the working position;
FIG. 3 shows in FIGS. 3A and 3B a cross-section of a conventional road which may be subject to grading using loose surface material in a conventional grading operation; and
FIG. 4 shows in FIGS. 4A to 4C an unmetalled roadway which may be repaired during an operation to move a load from a first to a second location.

FIG. 1 shows a vehicle 1 according to the invention. The vehicle passes along roadway 2 transferring a load from a first location to a second location. The vehicle 1 has a front part 3, including the driver cabin and a rear part 4 including an open box bed for carrying the load. The front part 3 and rear part 4 are linked by an articulated connection 14 and the front part is carried by wheels 5 on a single axle and the rear part 4 is carried by wheels 6 and 7, mounted on two rear axles.

The blade 8 is shown in the retracted position which suitably is higher than the differential casing (not shown). The blade 8 is mounted on the vehicle by mounting assembly 9, preferably two assemblies 9, located to either side of the central longitudinal axis of the vehicle. The mounting assembly 9 comprises a mounting point 10 for the blade 8 which allows rotatable movement of the blade 8. The mounting point 10 is located on connecting part 11 which is pivotally mounted on the rear part 4 of the vehicle 1. Actuation part 12 is linked to the blade 8 and is pivotally linked to hydraulic ram 13 and may act to rotate the blade 8 upon activation of hydraulic ram 13.

FIG. 2 shows the vehicle 1 of FIG. 1 with the blade 8 in the working position. Upon activation, hydraulic ram 13 extends and thereby moves actuation part 12 causing the blade 8 to rotate about mounting point 10. The mounting assembly 9 may be moved into the appropriate position by pivotal movement about the point at which it connects to the rear part 4 of the vehicle 1. The bottom edge of the grading blade 8 is suitably at the same level as a plane passing through the points of contact of the wheels 5, 6, 7 with the roadway 2 in the working position.

The blade 8 may be retracted into the retracted position shown in FIG. 1 independently of operation of the open box bed.

FIG. 3A shows a conventional operation to fill a pot-hole. A solid road is shown having a surface, for example gravel or asphalt 1 with a solid sublayer 2 and a pothole 3 in the surface 1. Loose material 4 for example gravel or chippings may be moved by a grader blade 5 on a conventional grader vehicle or load carrying vehicle having a grader blade.

Once the blade 5 has moved loose material 4 across pot-hole 3, the hole is filed. The bottom of the grader blade typically is above the solid surface 1 to reduce fouling and also a load-carrying vehicle with an underslung grader blade typically is not equipped with a high torque capability at low speeds.

In FIG. 4, according to the invention, unmetalled roadway 10 has a surface 11 in a serviceable state of repair to allow transit across it between location 1 and location 2 of a motorised vehicle 12 according to the invention which has an articulation 14 between a cabin and a load carrying open box and which is carrying a load. The vehicle has a retractable blade 13.

Through passing between location 1 and 2 in an outward pass with a load, by one or more vehicles, the roadway deteriorates as shown in FIG. 4B which has troughs 20 and crests 1. As the vehicle passes from location 2 to location 1, the blade 13 engages with the displaced roadway and as a consequence, smooths the roadway as shown in FIG. 4C to allow repeat passes.

1. A method of maintaining an unmetalled roadway between two locations which roadway is susceptible to deterioration the roadway being maintained during an operation to transfer a load from a first location to a second location by a repeated transit of a motorised vehicle along the roadway which, in an outward pass from the first location to the second location is laden with a part of the load and which in a return pass from the second location to the first location is unladen wherein the motorised vehicle comprises an open box bed for carrying the part of the load and a retractable blade which is movable relative to the said vehicle between a retracted position and a working position, the method comprising:
i) moving the part of the load in the said vehicle in the outward pass from the first location to the second location along the unmetalled roadway;
ii) depositing the part of the load at the second location;
iii) returning the vehicle in the return pass to the first location along the unmetalled roadway with the blade in the working position such that the blade is applied to the roadway during the return pass to reduce undulations or ruts and repair at least in part deterioration in the roadway; and
(iv) repeating steps i) to iii) at least once so as to move the load from the first location to the second location and to maintain the roadway during the return pass.

2. A method according to claim 1 wherein the blade is in the working position during the outward pass.

3. A method according to claim 1 wherein the roadway is in a quarry or mine or on a site for the construction of a major metalled road.

4. A method according to claim 1 wherein the motorised vehicle is articulated.

5. A method according to claim 1 wherein the blade contacts the roadway so as to reshape the surface of the roadway thereby to reduce undulations or ruts and repair at least in part deterioration in the roadway; and

6. A motorised vehicle adapted for use in maintaining an unmetalled roadway between two locations during an operation to transfer a load from a first location to a second location by a repeated transit of the motorised vehicle in a series of outward and return passes in which the vehicle in the outward pass is laden with a part of the load and causes deterioration of the unmetalled roadway, the vehicle comprising an open box bed for carrying a load, a front part carrying a driver cabin and at least one front axle and a rear part linked to the front part by an articulated connection and comprising at least one rear axle and a retractable blade mounted to the vehicle such that it is movable between a retracted position and a working position, the blade being located between the front axle and the at least one rear axle and wherein the blade does not extend beyond the width of the vehicle.

7. A motorised vehicle according to claim 6 wherein in the retracted position the blade is generally parallel to a plane through the front and rear axles and in the working position the blade contacts the ground and the bottom of the grader blade is at the same level as the ground contact point of the wheels rearward of the blade

8. A motorised vehicle according to claim 6 wherein the blade is hydraulically operable.

9. A motorised vehicle according to claim 6 wherein the blade and open box bed are independently operable.

10. A motorised vehicle according to claim 6 wherein the blade is mounted on the vehicle by means of a mounting assembly.

11. A motorised vehicle according to claim 10 wherein the mounting assembly comprises a connecting part mounted on the vehicle and the blade is rotatably mounted on the connecting part for rotation about an axis which is horizontally transverse to the longitudinal axis of the vehicle, an actuation part which is pivotally connected to the blade such that upon movement of the actuation part, the blade rotates about the transverse axis of rotation and a hydraulic ram operably connected to the connecting part and the actuation part such that upon movement of the ram, the actuation part is caused to move relative to the connecting part so as to effect rotation of the blade.

12. A motorised vehicle according to claim 6 wherein the blade is mounted on the vehicle by two mounting assemblies, located either side of the longitudinal axis of the vehicle.

13. A motorised vehicle according to claims 6 which comprises a front part carrying the driver cabin and at least one axle and a rear part comprising the open box bed and at least one axle wherein the front part and the rear part are linked by an articulated connection and the rear part carries the blade which is located forward of all the at least one axle on the rear part.

14. A motorised vehicle according to claim 6 which comprises at least three axles.

15. A motorised vehicle according to claim 6 which is a dumper truck,

16. A process for maintaining an unmetalled-roadway during transferal of a load from a first location to a second location by repeated transit in a series of outward and return passes of a motorised vehicle along the roadway where the roadway is susceptible to deterioration which comprises providing a motorised vehicle comprising an open box bed for carrying the load, a front part carrying a driver cabin and at least one front axle and a rear art linked to the front by an articulated connection and comprising at least one rear axle and a retractable blade mounted to the vehicle and being located between the front axle and the at least one rear axle which vehicle, in the outward pass, is laden with a part of the load and causes deterioration of the unmetalled roadway and which comprises moving the blade to the working position for the return pass such that the blade is applied to the roadway during the return pass to reduce undulations or ruts and repair at least in part deterioration in the roadway.
